(19) United States
(12) Patent Application Publication
(10) Pub. No.: US 2025/0241809 A1
(43) Pub. Date: Jul. 31, 2025

(54) TURNING A PERSON IN A BED

(71) Applicant: CARETURNER A/S, Herlev (DK)

(72) Inventors: Michael KOCK, Allerød (DK); Jens Kristian GOTH, Greve (DK); Vasile GURAU, Fraderiksberg (DK); Anders Rørdam MICHELSEN, Viby Sjælland (DK)

(73) Assignee: CARETURNER A/S, Herlev (DK)

(21) Appl. No.: 18/855,937

(22) PCT Filed: Apr. 21, 2023
(86) PCT No.: PCT/EP2023/060470

§ 371 Date: Oct. 10, 2024

(30) Foreign Application Priority Data
Apr. 22, 2022 (EP) 22169426.8
Jul. 4, 2022 (EP) 22182869.2

(51) Int. Cl. A61G 7/00; A61G 7/057

(52) U.S. Cl. CPC A61G 7/001; A61G 7/057

(57) ABSTRACT

A bed system attachable to a bed for turning a person and a bed comprising such bed system is disclosed. The bed system comprises a first element and a second element. The first element and the second element are hingedly attached along a first hinge axis, an upper surface of the first element extends perpendicularly to the first hinge axis from a primary edge to a secondary edge of the first element. In a lowered rotational position of the first element relative to the second element, a lowered distance between the secondary edge of the first element and the lower surface of the second element is less than 8 cm, and wherein in a raised rotational position, a raised distance between the secondary edge of the first element and the lower surface of the second element is at least 5 cm more than the lowered distance. The lower surface of the second element is attachable to a top surface of a bed base of the bed, such as to arrange the bed system between the bed base and the mattress of the bed.

The present disclosure relates to a system attachable to beds. More specifically the present disclosure relates to a bed system mountable to a bed to facilitate reposition of a person in the bed to reduce the likelihood of bedsores.

### BACKGROUND

Elderly and disabled people who spend long periods of time in bed are susceptible to bedsores. These people must be repositioned frequently in order to reduce the likelihood of bedsores. At present, health and safety regulations stipulate that often two, sometimes three people must be used to turn the bedridden. Thus, such care is extremely labour intensive. In addition, it may put large strains on the people turning the person. In addition, a great number of disabled people find it very difficult or even impossible to either adjust their sleeping position or to rise from a prone position, e.g. during the night when not having immediate access to the help of another person. Thus, an automated or semi-automatic function for turning or repositioning of a person in a bed is desirous.

Some systems to facilitate turning and repositioning of persons in a bed are known. However, most of these system forms an integrated part of the entire bed, and therefore is an expensive method for providing such system. Hence, it is desirous to provide a system which can be fitted to an existing bed. Furthermore, it is desirous to provide a system, which can be easily attached to a vast variety of different beds, with no or minimal need to adapt the bed itself.

### SUMMARY

It is an object of the present disclosure to at least provide improvements of the prior art and/or to solve or reduce problems known from the prior art. Furthermore, by the present disclosure a bed system is provided, which facilitates simple installation on an existing bed, limiting or avoiding the need for modification of the existing bed. Also, a bed with the bed system is disclosed.

Accordingly, a bed system attachable to a bed for turning a person, e.g. in order to avoid pressure ulcers and/or to aid a caregiver in repositioning the person, is disclosed. Also a bed comprising such bed system is disclosed. The bed comprises a bed base with a top surface for supporting a mattress, the bed system may be arranged between the bed base and the mattress. The bed may be a hospital bed or nursing bed. The person may be a patient, such as a bed bound patient.

The bed system comprises a first element and a second element. The first element has an upper surface being substantially planar. The second element has a lower surface being substantially planar.

The first element and the second element are hingedly attached along a first hinge axis. The upper surface of the first element extends perpendicularly to the first hinge axis from a primary edge to a secondary edge of the first element. The lower surface of the second element may extend perpendicularly to the first hinge axis from a primary edge to a secondary edge of the second element.

In a lowered rotational position of the first element relative to the second element, a lowered distance between the secondary edge of the first element and the lower surface of the second element, such as the secondary edge of the second element, is less than 8 cm, such as less than 6 cm, such as less than 5 cm, such as less than 4 cm. In a raised rotational position of the first element, a raised distance between the secondary edge of the first element and the lower surface of the second element, such as the secondary edge of the second element, is at least 5 cm more than the lowered distance, such as at least 8 cm more than the lowered distance, such as at least 10 cm more than the lowered distance, such as at least 15 cm more than the lowered distance, such as at least 20 cm more than the lowered distance.

The bed system further comprises a first actuator attached to the first element and/or the second element. The first actuator has a first actuating rod extendible and/or retractable perpendicular to the first hinge axis between a retracted actuator position and an extended actuator position. The first actuating rod extends and/or retracts in a space between the first element and the second element to effectuate change of the rotational position of the first element relative to the second element between the lowered rotational position and the raised rotational position. The first actuator may be arranged above the second element. The first actuator may be arranged between the first element and the second element.

The lower surface of the second element is attachable to a top surface of a bed base of the bed, e.g. such as to arrange the bed system between the bed base and the mattress of the bed. The lower surface of the second element may be attachable to the top surface of the bed base, e.g. by fasteners, such as straps or strips, bolts and nuts and/or screws, such as self-tapping or self-drilling screws, or other means known in the art for attachment. The lower surface of the second element may be abutting the top surface when attached to the top surface.

The present inventors have found that by the present disclosure the need for altering any conventional bed to support a system for turning a person in the bed, e.g. to avoid pressure ulcers and/or to aid a caregiver in repositioning the patient, is reduced. Furthermore, the present disclosure also provides for a system, which, e.g. due to the reduced necessity for alterations of the bed, is more flexible, i.e. it may be used in combination with an increased range of different beds. In some examples, the bed system may be devoid of parts extending below the lower surface of the second element. Particularly, the actuator(s), such as the first actuator and/or the second actuator (which will be described below) may be devoid of parts extending below the lower surface of the second element. In other words, the actuator(s) may be arranged above the second element.

The inventors have also found that it is important to observe the height of the side rails of the bed. To protect against inadvertent patient falls, height of the top edge of side rails of a bed, e.g. in a hospital setting, should preferably be at least 220 mm above the mattress. Since the disclosed bed system is to be placed between the bed base and the mattress, it will decrease the distance between the top of the side rails and the top of the mattress. Hence, to reduce the necessity of altering the height of the side rails to observe the height difference of 220 mm, the disclosed bed system should be relatively slim. In view of this, and conventionally used mattresses, the inventors have found that the bed system in its lowered position should be less than 8 cm, more preferably less than 6 cm, more preferably less than 5 cm, more preferably less than 4 cm. Thus, in addition to the already described advantages, the present disclosure also provides for a bed system which may be used with conventional mattresses, beds and/or side rails.

Hence, by the present disclosure a bed system is disclosed, which facilitates simple installation on an existing bed, reducing or avoiding the need for modification of the existing bed. For example, by the present disclosure, the bed system may be attached directly to the top surface of the bed base, without having to remove bed slats or cutting out parts of the bed base to make room for retrofitting the bed system. Thus, all structural integrity of the bed is maintained, installation is made easier, and the disclosed bed system may be used in combination with an increased range of different beds.

It has further been found that an additional advantage of the slim bed system, as disclosed herein, is that the work height for a caregiver is not significantly altered by the installation of the disclosed system, thus facilitating maintenance of a caregiver's already obtained ergonomic settings.

The bed system may comprise a third element. The third element may have an upper surface being substantially planar.

The third element and the second element may be hingedly attached along a second hinge axis. The second hinge axis may be parallel to the first hinge axis. The upper surface of the third element may extend perpendicularly to the second hinge axis, e.g. from a primary edge to a secondary edge of the third element. The first hinge axis and the second hinge axis may be close to each other. The distance between the first hinge axis and the second hinge axis may be smaller than (e.g. less than ½ or less than ⅓ of) the distance between the first hinge axis and the secondary edge of the second element, and/or smaller than (e.g. less than ½ or less than ⅓ of) the distance between the second hinge axis and the primary edge of the second element, and/or smaller than (e.g. less than ½ or less than ⅓ of) the distance between the first hinge axis and the secondary edge of the first element, and/or smaller than (e.g. less than ½ or less than ⅓ of) the distance between the second hinge axis and the secondary edge of the third element. The second hinge axis and the first hinge axis may be arranged within a middle portion of the second element. For example, the distance between first hinge axis and the secondary edge of the second element may be the same or substantially the same as the distance between the second hinge axis and the primary edge of the second element.

Alternatively, the bed system may comprise the third element and a fourth element, and the third element and the fourth element may be hingedly attached along a second hinge axis. The second hinge axis may be parallel to the first hinge axis. The second hinge axis of this alternative may be the same as the second hinge axis mentioned above, hence reference to a second hinge axis in the following apply to the second hinge axis of either of these alternatives. Also, in this case the upper surface of the third element may extend perpendicularly to the second hinge axis, e.g. from a primary edge to a secondary edge of the third element. The fourth element may have a lower surface being substantially planar. The lower surface of the fourth element may be attachable to the top surface of the bed base of the bed. The lower surface of the fourth element may be attachable to the top surface of the bed base, e.g. by fasteners, such as straps or strips, bolts and nuts and/or screws, such as self-tapping or self-drilling screws, or other means known in the art for attachment. The lower surface of the second element may be abutting the top surface when attached to the top surface.

The lower surface of the fourth element may extend perpendicularly to the second hinge axis from a primary edge to a secondary edge of the fourth element. In some examples, the bed system may be devoid of parts extending below the lower surface of the fourth element. Particularly, the actuator(s), such as the first actuator and/or the second actuator (which will be described below) may be devoid of parts extending below the lower surface of the fourth element. In other words, the actuator(s) may be arranged above the fourth element.

Thus, in one example, the first element and the second element (optionally together with other components, e.g. the first actuator) may form a first module and the third element and the fourth element (optionally together with other components, e.g. a second actuator) may form a second module, which may be substantially similar to the first module. In such example, the first module may be provided at one lateral side area of the bed, e.g. between the centre and a first lateral side of the bed, to facilitate turning in one direction, while the second module may be provided at the opposite lateral side area of the bed, e.g. between the centre and a second lateral side of the bed, to facilitate turning in the opposite direction. The first module and the second module being separate may offer more flexibility when attaching the bed system to accommodate different body sizes. Despite being separate modules, the first module and the second module may be mutually connected by a distance piece (for example an adjustable distance piece) to ensure that the distance between the modules remains fixed upon use of the bed system.

Providing separate first and second modules may further simplify and lower costs of production, as the first and second modules may be similar.

In the other example, the second element may form a common base for both the first element and the third element, wherein the first element is attached to the second element to facilitate turning in one direction and the third element is attached to the second element to facilitate turning in the opposite direction. In this example, the module comprising the first element, the second element and the third element may be attached at a laterally centred position of the bed, with the secondary edge of the first element extending towards one lateral side of the bed and the secondary edge of the third element extending towards the opposite lateral side of the bed. The second element forming a common base for both the first element and the third element may facilitate easier attachment of the combined module to the bed (relative to two separate modules) and may ensure that a relative, e.g. predetermined, positioning of the first element and the third element is maintained upon use of the bed system.

In the example where the third element and the second element are hingedly attached along the second hinge axis: In a lowered rotational position of the third element relative to the second element, a lowered distance between the secondary edge of the third element and the lower surface of the second element, such as the primary edge of the second element, is less than 8 cm, such as less than 6 cm, such as less than 5 cm, such as less than 4 cm. In a raised rotational position of the third element, a raised distance between the secondary edge of the third element and the lower surface of the second element, such as the primary edge of the second element, is at least 5 cm more than the lowered distance, such as at least 8 cm more than the lowered distance, such as at least 10 cm more than the lowered distance, such as at least 15 cm more than the lowered distance, such as at least 20 cm more than the lowered distance. In this example, the first hinge axis and the second hinge axis may be arranged such that, at least in the lowered rotational positions of the first element and the third element relative to the second element, the first hinge axis and the second hinge axis are located between the secondary edge of the first element and the secondary edge of the second element.

In the other example where the third element and the fourth element are hingedly attached along the second hinge axis: In a lowered rotational position of the third element relative to the fourth element, a lowered distance between the secondary edge of the third element and the lower surface of the fourth element, such as the secondary edge of the fourth element, is less than 8 cm, such as less than 6 cm, such as less than 5 cm, such as less than 4 cm. In a raised rotational position of the third element, a raised distance between the secondary edge of the third element and the lower surface of the fourth element, such as the secondary edge of the fourth element, is at least 5 cm more than the lowered distance, such as at least 8 cm more than the lowered distance, such as at least 10 cm more than the lowered distance, such as at least 15 cm more than the lowered distance, such as at least 20 cm more than the lowered distance. In this example, the two modules are preferably arranged such that, at least in the lowered rotational positions of the first element and the third element, the first hinge axis and the second hinge axis are located between the secondary edge of the first element and the secondary edge of the second element.

The bed system may comprise a second actuator. The second actuator may be attached to the third element and/or the second element. Alternatively, the second actuator may be attached to the third element and/or the fourth element. The second actuator may have a second actuating rod extendible and/or retractable perpendicular to the second hinge axis, e.g. between a retracted actuator position and an extended actuator position. The second actuating rod may extend and/or retract in a space between the third element and the second element, e.g. to effectuate change of the rotational position of the third element relative to the second element between the lowered rotational position and the raised rotational position. In this example, the second actuator may be arranged above the second element and/or the second actuator may be arranged between the third element and the second element. Alternatively, the second actuating rod may extend and/or retract in a space between the third element and the fourth element to effectuate change of the rotational position of the third element relative to the fourth element between the lowered rotational position and the raised rotational position. In this example, the second actuator may be arranged above the fourth element and/or the second actuator may be arranged between the third element and the fourth element.

The first hinge axis and the second hinge axis may be substantially parallel. The first actuating rod and the second actuating rod may be extending and/or retracting in substantially opposite directions. For example, the first actuating rod and the second actuating rod may extend towards each other. For example, the first actuator and the second actuator may be arranged along the same direction, e.g. such that the first actuating rod and the second actuating rod are extending and/or retracting along substantially the same direction. The first actuator and the second actuator may be arranged side by side, e.g. such that the first actuating rod and the second actuating rod are extending and/or retracting along substantially parallel offset directions.

Preferably, change of the rotational position of the first element relative to the second element between the lowered rotational position and the raised rotational position, is effectuated in a single stage. Similarly, change of the rotational position of the third element relative to the second element or the fourth element between the lowered rotational position and the raised rotational position, is preferably effectuated in a single stage. By the term “single stage” is meant that the same mechanical interaction between an actuator and the respective element(s) is causing the change of the rotational position throughout the rotation between the lowered rotational position and the raised rotational position. Thus, by a “single stage” is meant that a transition between one lifting method and a second lifting method is avoided. Thereby, a simpler mechanism may be achieved.

The first element may have one or more first wedge structures facing the second element. The one or more first wedge structures may be positioned to engage with the first actuating rod, e.g. such that extension or retraction of the first actuating rod causes engagement with the one or more first wedge structures and an oppositely arranged part of the second element, e.g. one or more second wedge structures, resulting in increase of the angle between the first element and the second element and/or increase of the distance between the secondary edge of the first element and the lower surface of the second element. In some examples, a distal end of the first actuating rod may cause the engagement with the one or more first wedge structures. The engagement of the first actuating rod with the one or more first wedge structures may result in change of the rotational position of the first element relative to the second element from the lowered rotational position to the raised rotational position.

The first actuating rod may be T-shaped. For example, the first actuator may have a longitudinal rod part extending along the direction of extension and/or retraction of the first actuating rod and a transversal rod part at a distal end of the longitudinal rod part. The one or more first wedge structures may be a plurality of first wedge structures. The one or more first wedge structures may comprise a first primary wedge structure and a first secondary wedge structure being arranged on opposite sides of the longitudinal rod part of the first actuating rod. The one or more first wedge structures may engage with the transversal rod part of the first actuating rod.

The one or more first wedge structures may each comprise an engagement surface facing the second element. The engagement surface may form an engagement angle relative to the upper surface of the first element. The engagement angle of the engagement surface relative to the upper surface of the first element may be gradually changing, e.g. decreasing, towards the first hinge axis, e.g. from an initial engagement surface position. The initial engagement surface position may be the part of the engagement surface engaging with the first actuating rod in the lowered rotational position of the first element. The engagement surface may be curved, relative to the upper surface of the first element, along the direction of extension and/or retraction of the first actuating rod. In some examples, the engagement angle is zero, i.e. the engagement surface is parallel with the upper surface of the first element, at an intermediate engagement surface position. The intermediate engagement surface position may be between the initial engagement surface position and a final engagement surface position. The final engagement surface position may be closer to the first hinge axis than the initial engagement surface position. The engagement angle, e.g. between the initial engagement surface position and the intermediate engagement surface position and/or between the intermediate engagement surface position and the final engagement surface position, may have a magnitude of less than 45 degrees, such as less than 35 degrees, such as less than 30 degrees. The engagement angle between the initial engagement surface position and the intermediate engagement surface position may be opposite the engagement angle between the intermediate engagement surface position and the final engagement surface position.

The third element may have one or more third wedge structures facing the second element or the fourth element. The one or more third wedge structures may be positioned to engage with the second actuating rod, e.g. such that extension or retraction of the second actuating rod causes engagement with the one or more third wedge structures and an oppositely arranged part of the second element or fourth element, e.g. one or more second wedge structures or fourth wedge structures, resulting in increase of the angle between the third element and the second element or fourth element and/or increase of the distance between the secondary edge of the third element and the lower surface of the second element or fourth element. In some examples, a distal end of the second actuating rod may cause the engagement with the one or more third wedge structures. The engagement of the second actuating rod with the one or more third wedge structures may result in change of the rotational position of the third element relative to the second element or fourth element from the lowered rotational position to the raised rotational position. The second actuating rod may be T-shaped. For example, the second actuator may have a longitudinal rod part extending along the direction of extension and/or retraction of the second actuating rod and a transversal rod part at a distal end of the longitudinal rod part. The one or more third wedge structures may be a plurality of third wedge structures. The one or more third wedge structures may comprise a third primary wedge structure and a third secondary wedge structure being arranged on opposite sides of the longitudinal rod part of the second actuating rod. The one or more third wedge structures may engage with the transversal rod part of the second actuating rod.

The one or more third wedge structures may each comprise an engagement surface facing the second element or the fourth element. The engagement surface may form an engagement angle relative to the upper surface of the third element. The engagement angle of the engagement surface relative to the upper surface of the third element may be gradually changing, e.g. decreasing, towards the second hinge axis, e.g. from an initial engagement surface position. The initial engagement surface position may be the part of the engagement surface engaging with the second actuating rod in the lowered rotational position of the third element. The engagement surface may be curved, relative to the upper surface of the third element, along the direction of extension and/or retraction of the second actuating rod. In some examples, the engagement angle is zero, i.e. the engagement surface is parallel with the upper surface of the first element, at an intermediate engagement surface position. The intermediate engagement surface position may be between the initial engagement surface position and a final engagement surface position. The final engagement surface position may be closer to the second hinge axis than the initial engagement surface position. The engagement angle, e.g. between the initial engagement surface position and the intermediate engagement surface position and/or between the intermediate engagement surface position and the final engagement surface position, may have a magnitude of less than 45 degrees, such as less than 35 degrees, such as less than 30 degrees. The engagement angle between the initial engagement surface position and the intermediate engagement surface position may be opposite the engagement angle between the intermediate engagement surface position and the final engagement surface position.

The first actuating rod may be not coupled, e.g. not fastened, to the first element. Alternatively or additionally, the first actuating rod may be not coupled, e.g. not fastened, to the second element. Similarly or alternatively, The second actuating rod may be not coupled, e.g. not fastened, to the third element. Alternatively or additionally, the second actuating rod may be not coupled, e.g. not fastened, to the second element or fourth element. Thus, a rigid connection between an actuating rod and the respective element may be avoided. Thereby, the elements may be more easily displaced manually if needed, e.g. if servicing the system. Furthermore, a non-coupling between the actuating rod and its respective element may reduce the risk of pinch injuries.

The first element and/or the second element and/or the third element and/or the fourth element may comprise an opening, which may allow at least a part of an actuator, such as the first actuator or the second actuator to protrude through the opening. For example, the first element may comprise an opening allowing at least a part of the first actuator or the second actuator to protrude through the opening. The second element may comprise an opening allowing at least a part of the first actuator or the second actuator to protrude through the opening. The third element may comprise an opening allowing at least a part of the first actuator or the second actuator to protrude through the opening. The fourth element may comprise an opening allowing at least a part of the first actuator or the second actuator to protrude through the opening. In an example, the first element comprises a first opening allowing at least a part of the second actuator to protrude through the first opening and optionally the third element may comprise a third opening allowing at least a part of the first actuator to protrude through the third opening. The second element may comprise a primary second opening allowing at least a part of the first actuator to protrude through the primary second opening and a secondary second opening allowing at least a part of the second actuator to protrude through the secondary second opening. Providing one or more of the elements with openings for protrusion of at least parts of the one or more actuators facilitates the bed system being as slim as possible in the lowered position, as the actuator(s) may be the most space requiring component.

In both of the above examples, the bed system may be attached to the bed such that the hinge axes are located near the lateral centre of the bed, and where the secondary edge of the first element is arranged towards one lateral side of the bed and the secondary edge of the third element is arranged towards the other opposite lateral side of the bed. Such arrangement facilitates the turning of the person, while also facilitating a possibility of the first element and the third element to work in unison to provide a gentler and more controlled turning of the person. For example, if turning the person from the lateral area in which the first element is positioned, both the first element and the third element may be partly raised, and afterwards the first element may be further raised while lowering the third element, thereby the partly raised third element act as a stop for the person being turned to avoid an uncontrolled roll of the person. Turning of the person, i.e. by raising and lowering the first element and optionally the third element, may be controlled by a control unit (e.g. comprising a processing unit and electronic memory). The control unit may be connected, e.g. wired, to the first actuator and/or to the second actuator. For example, a first cable may connect the control unit to the first actuator and/or a second cable may connect the control unit to the second actuator. The control unit may be adapted to control extension and/or retraction of the first actuator and/or the second actuator. The control unit may be adapted to control extension and/or retraction of the first actuator independently of the extension and/or retraction of the second actuator. The bed system and the control unit may form a bed system assembly. The bed system assembly may further comprise the first cable and/or the second cable. The control unit may be operated by manual input, e.g. via a user interface of the control unit. Alternatively or additionally, the control unit may be programmed to automatically raise and/or lower the first element and optionally the third element, e.g. by controlling extension and/or retraction of the first actuator and/or the second actuator, in accordance with stored instructions. Accordingly, the electronic memory of the control unit may store these instructions. The stored instructions may further include instructions to raise and/or lower the first element and optionally the third element, e.g. by controlling extension and/or retraction of the first actuator and/or the second actuator, in accordance with a time based value. For example, the system may be configured to turn the person in the bed every 2 hours or every 3 hours.

It may be desired that only raising of the first element and/or the third element are provided as an active process, while lowering of the elements may be provided as a passive process, such as to avoid or decrease the risk of pinch injuries. The first actuator may be configured to actively extend the first actuating rod from the retracted actuator position to the extended actuator position, and the first actuator may be configured to release the first actuating rod, such as to allow the first actuating rod to retract from the extended actuator position to the retracted actuator position by force being applied, e.g. to the first element and/or the second element. Similarly, the second actuator may be configured to actively extend the second actuating rod from the retracted actuator position to the extended actuator position, and the second actuator may be configured to release the second actuating rod, such as to allow the second actuating rod to retract from the extended actuator position to the retracted actuator position by force being applied, e.g. to the third element and/or the second or fourth element. Alternatively, the first actuator may be configured to actively retract the first actuating rod from the extended actuator position to the retracted actuator position, and the first actuator may be configured to release the first actuating rod, such as to allow the first actuating rod to extend from the retracted actuator position to the extended actuator position by force being applied, e.g. to the first element and/or the second element. Similarly, the second actuator may be configured to actively retract the second actuating rod from the extended actuator position to the retracted actuator position, and the second actuator may be configured to release the second actuating rod, such as to allow the second actuating rod to extend from the retracted actuator position to the extended actuator position by force being applied, e.g. to the third element and/or the second element or fourth element.

Each of the first element and/or the third element may extend from a head side end to a foot side end along the first hinge axis and/or the second hinge axis. The bed system may comprise a first primary extension element flexibly attached to the head side end of the first element. The first primary extension element may have an upper surface being substantially planar. The bed system may comprise a first secondary extension element flexibly attached to the foot side end of the first element. The first secondary extension element may have an upper surface being substantially planar. The bed system may comprise a third primary extension element flexibly attached to the head side end of the third element. The third primary extension element may have an upper surface being substantially planar. The bed system may comprise a third secondary extension element flexibly attached to the foot side end of the third element. The third secondary extension element may have an upper surface being substantially planar. The flexible attachment between the extension element(s) and the first element and/or third element may allow rotation and/or tilting of the extension element(s) relative to the first and/or third element, which enhance comfort for the person being turned, while still providing the turning action to be provided along a longer length of the person. Furthermore, the flexible attachment between the extension element(s) and the first element and/or third element may allow use of any elevating functions of the bed while the disclosed bed system is installed.

It will be understood that elements and extension elements referred to above and being described as having surfaces being “substantially planar” may in some embodiments be in the form of flat plates of appropriates shapes. It will further be understood that such elements and extension elements may have one or several openings, notches or carvings insofar that such openings, indents, notches or carvings are not contrary to the functioning of the elements and extension elements. In particular, the second element and the fourth element (if present) preferably have appropriate openings, like holes and slots, or bends, for attaching the respective elements to the top surface of the bed, and for mounting the actuators, wedges, or other structures to the elements, and for providing the hinge functionalities with the first element and third element.

The first element may have a distance between the first hinge axis and the secondary edge. The distance between the first hinge axis and the secondary edge of the first element may be more than 250 mm, such as more than 275 mm, such as more than 300 mm. The upper surface of the first element may be formed by a first plate element. The first plate element may have a thickness between 0.1 mm and 10 mm, such as between 0.1 mm and 5 mm, such as between 0.1 mm and 4 mm. In some examples, the first plate element may have a thickness of more than 1 mm, such as between 1 mm and 10 mm, such as between 1 mm and 5 mm, such as between 1 mm and 4 mm. In some examples, the first plate element may have a thickness of more than 2 mm, such as between 2 mm and 10 mm, such as between 2 mm and 5 mm, such as between 2 mm and 4 mm. In some examples, the first plate element may have a thickness of more than 3 mm, such as between 3 mm and 10 mm, such as between 3 mm and 5 mm, such as between 3 mm and 4 mm.

The third element may have a distance between the second hinge axis and the secondary edge. The distance between the second hinge axis and the secondary edge of the third element may be more than 250 mm, such as more than 275 mm, such as more than 300 mm. The upper surface of the third element may be formed by a third plate element. The third plate element may have a thickness between 0.1 mm and 10 mm, such as between 0.1 mm and 5 mm, such as between 0.1 mm and 4 mm. In some examples, the third plate element may have a thickness of more than 1 mm, such as between 1 mm and 10 mm, such as between 1 mm and 5 mm, such as between 1 mm and 4 mm. In some examples, the third plate element may have a thickness of more than 2 mm, such as between 2 mm and 10 mm, such as between 2 mm and 5 mm, such as between 2 mm and 4 mm. In some examples, the third plate element may have a thickness of more than 3 mm, such as between 3 mm and 10 mm, such as between 3 mm and 5 mm, such as between 3 mm and 4 mm.

The disclosed bed may comprise the disclosed bed system. For example, the second element, and optionally the fourth element (if present), may be attached to the top surface of the bed, e.g. such that the bed system is arranged between the bed base and the mattress. The top surface of the bed may be formed by slats of the bed base. Hence, the lower surface of the second element and/or of the fourth element may be attachable to the slats of the bed base.

The second element and optionally the fourth element (if present) may be attached to the top surface at a position corresponding to the hip of the person. The bed may have bed length from a head end to a foot end. The second element and/or the fourth element may be attached to the top surface at a position between 30-70%, such as between 40-70%, of the bed length from the head end. For example, a head side end of the second element and/or the fourth element may be spaced from the head end of the bed by between 30-50% of the bed length, such as between 35-45% of the bed length, such as between 40-45% of the bed length. The second element, and optionally the fourth element (if present), may be attached to a part of the top surface, which is fixed, i.e. not movable as part of elevating functions of the bed.

In an example a first module of the bed system, e.g. comprising the first element, the second element and the first actuator, may be attached to one lateral side area, e.g. between the centre and a first lateral side, e.g. the right side area, of the top surface of the bed, and a second module of the bed system, e.g. comprising the third element, the fourth element and the second actuator, may be attached to the other lateral side area, e.g. between the centre and a second lateral side, e.g. the left side area, of the top surface of the bed. In another example, e.g. wherein the second element forms a common base for both the first element and the third element, the bed system, may be attached to the centre of the top surface of the bed.

The upper surface of the first element and/or the upper surface of the third element may be coated. Coating the upper surface(s) may be provided to control the friction between the upper surface(s) and the mattress. Furthermore, coating the upper surface(s) may prolong the durability of the bed system. Coating may also have other advantages, such as being easier to clean and/or having an anti-pathogenic effect.

Generally, the upper surface(s) mentioned herein, e.g. the upper surface of the first element and/or the upper surface of the third element may, at least when the respective first element and/or third element is in the lowered position, be facing oppositely than the lower surface(s) mentioned herein, e.g. the lower surface of the second element and/or the lower surface of the fourth element. In other words, an upper surface is intended to face towards the mattress, and the lower surface is intended to face towards the bed base, when the bed system is arranged in the bed.

### BRIEF DESCRIPTION OF THE FIGURES

Embodiments of the disclosure will be described in more detail in the following with regard to the accompanying figures. The figures show one way of implementing the present disclosure and are not to be construed as being limiting to other possible embodiments falling within the scope of the attached claim set.

FIG. 1 is a schematic diagram illustrating an exemplary bed and a person in the bed,

FIG. 2 is a schematic diagram illustrating an exemplary bed, including a bed system or part thereof,

FIG. 3 are schematic diagrams illustrating an exemplary bed system or part thereof,

FIG. 4 are schematic diagrams illustrating an exemplary bed system or part thereof, and

FIGS. 5a and 5b schematically illustrate exemplary shapes of wedge structures.

### DETAILED DESCRIPTION

Various exemplary embodiments and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the invention or as a limitation on the scope of the invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

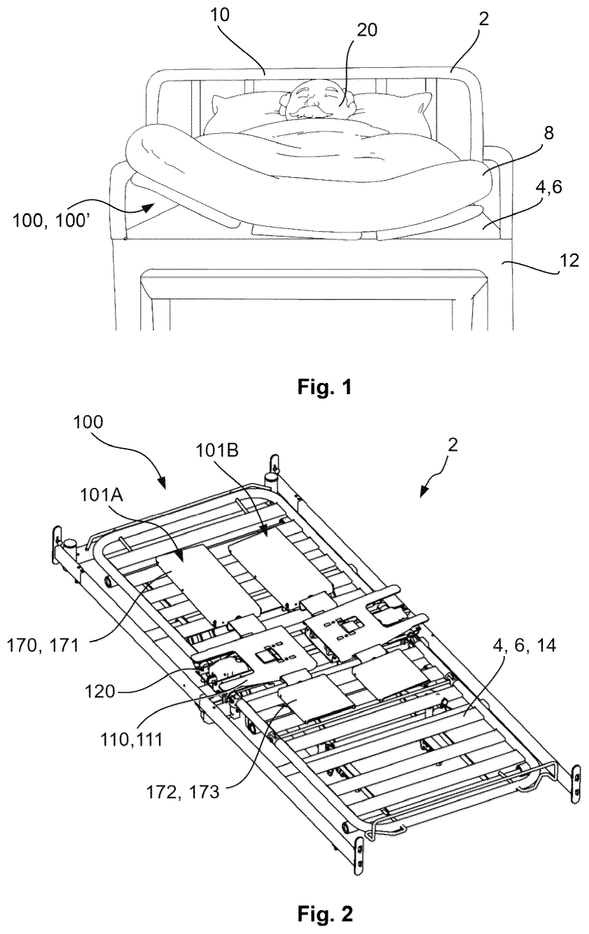

FIG. 1 is a schematic diagram illustrating an exemplary bed 2 and a person 20 in the bed 2. The bed 2 may be a hospital bed and/or the person 20 may be a patient. For example, the person 20 may be a bedbound patient. The bed extends from a head end 10 to a foot end 12. The bed 2 comprises a bed base 4 with a top surface 6 for supporting a mattress 8. The bed 2 further comprises a bed system 100, 100′ for turning the person 20, such as to avoid pressure sores and/or to aid a caregiver in repositioning the person 20. The bed system 100 is arranged between the bed base 4 and the mattress 8 and attached to the bed base 4, such as to the top surface 6 of the bed base 4.

FIG. 2 is a schematic diagram illustrating an exemplary bed 2 without a mattress. In the illustrated example, the bed system 100, or at least part of the bed system 100, is shown, wherein the bed system is attached to the bed base 4, which in the illustrated example is formed by slats 14, to which the bed system may be attached. The illustrated example shows the bed system 100 comprising a first element 110 and a second element 120 being hingedly attached, such as to allow rotational repositioning of the first element 110 relative to the second element 120, in order to turn the person. More specifically, the first element 110 comprises an upper surface 111 being substantially planar, which acts to turn the person when rotationally repositioning the first element 110 relative to the second element 120.

The second element 120 is attached to the bed base 4 and/or the top surface 6 at a position corresponding to the hip of the person.

The illustrated bed system 100 or part of a bed system 100 further comprises a first primary extension element 170 and a first secondary extension element 172. The first primary extension element 170 is flexibly attached to a head side end of the first element 110. The first secondary extension element 172 is flexibly attached to a foot side end of the first element 110.

The first primary extension element 170 and the first secondary extension element 172 each have an upper surface 171, 173 being substantially planar. The upper surfaces 171, 173 of the first primary extension element 170 and the first secondary extension element 172 aids to turn the person when the first element 110 is rotationally repositioned relative to the second element 120.

In the illustrated example, the bed system 100 comprises a first module 101A comprising the above described features. Furthermore, as illustrated, the bed system may comprise a second module 101B comprising similar features, as described above. As illustrated the first module 101A and the second module 101B may be provided on opposite sides of the bed 2, such as to facilitate turning in the opposite direction. Alternatively, as will be further explained below, the bed system may be realised by a solution integrating both sides in one module.

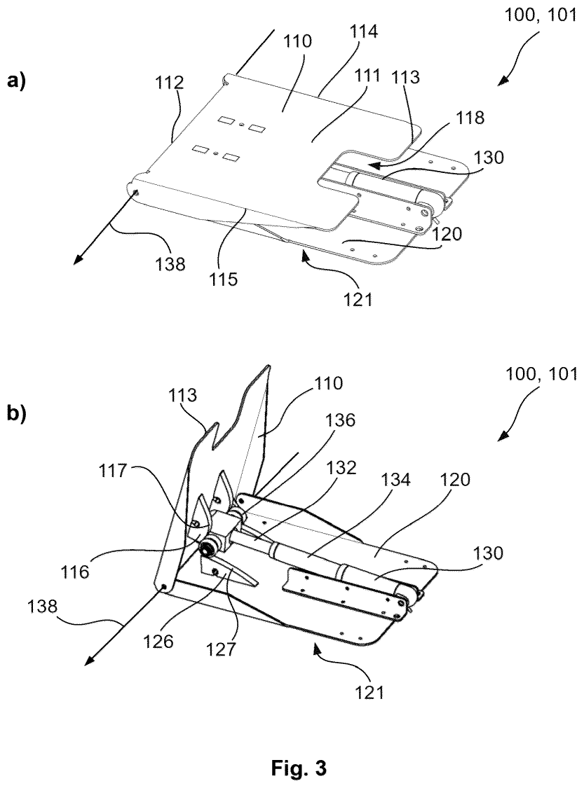

FIG. 3 are schematic diagrams illustrating an exemplary bed system 100 or part of an exemplary bed system 100. More particularly, FIG. 3 illustrates a module 101 of the bed system 100, such as the first module 101A and/or the second module 101B of FIG. 2. The exemplary bed system 100, such as the exemplary module 101, is attachable to a bed as illustrated in FIG. 2, e.g. by fasteners, such as straps or strips, bolts and nuts and/or screws, such as self-tapping or self-drilling screws, or other means known in the art for attachment.

The bed system 100, such as the exemplary module 101, comprises a first element 110 and a second element 120. The first element 110 has an upper surface 111 being substantially planar. The second element 120 has a lower surface 121 being substantially planar. The lower surface 121 of the second element 120 is attachable to a top surface of a bed base of the bed, e.g. by fasteners, such as straps or strips, bolts and nuts and/or screws, such as self-tapping or self-drilling screws, or other means known in the art for attachment, such as to arrange the bed system 100 between the bed base and the mattress of the bed, as illustrated in FIG. 1. It will be understood that the bed system is a separate arrangement from the bed and may be attached to the top surface of a bed base in a removable manner, so as to allow for later detachment and repositioning of the bed system on the top surface of the bed base to accommodate different body shapes or body sizes, and/or to facilitate the bed system to be removed from one bed and installed on another (e.g. new) bed.

The first element 110 and the second element 120 are hingedly attached along a first hinge axis 138. The upper surface 111 of the first element 110 extends perpendicularly to the first hinge axis 138 from a primary edge 112 to a secondary edge 113 of the first element.

In a lowered rotational position, as shown in FIG. 3a, of the first element 110 relative to the second element 120, a lowered distance between the secondary edge 113 of the first element 110 and the lower surface 121 of the second element 120 is less than 8 cm, such as less than 6 cm, such as less than 5 cm, such as less than 4 cm. Thereby, the bed system 100 may be fitted between an existing bed base of the bed and a mattress with reduced or eliminated need to alter the height of a bed rail, while providing a possibility of fitting the bed system to a bed with a reduced need of altering the bed base, as parts extending below the lower surface 121 is dispensed with or at least reduced.

In a raised rotational position, as shown in FIG. 3b, of the first element 110 relative to the second element 120, a raised distance between the secondary edge 113 of the first element 110 and the lower surface 121 of the second element 120 is more than the lowered distance, as shown in FIG. 3a, such as at least 5 cm more than the lowered distance, such as at least 8 cm, such as at least 10 cm, 15 cm, or 20 cm, more than the lowered distance. In some situations, e.g. when turning the person during sleep, the first element 110 may be raised to a lower than maximum raised position during turning, while the maximum raised position may be used when the bed system 100, such as the exemplary module 101 of the bed system 100, is used during repositioning of the person. In some examples the maximum raised position, e.g. wherein the angle between the first element 110 and the second element 120 is above 70 degrees, may correspond to a raised distance between the secondary edge 113 of the first element and the lower surface 121 of the second element 120 between 34-38 cm (e.g. about 30 cm more than the lowered distance). The angle between the first element 110 and the second element 120 is increased when raising the first element 110. For example, an angle of 10 degrees may result in a raised distance between 10-14 cm (e.g. about 6 cm more than the lowered distance), an angle of 40 degrees may result in a raised distance between 25-29 cm (e.g. about 21 cm more than the lowered distance), and an angle of 70 degrees may result in a raised distance between 33-37 cm (e.g. about 29 cm more than the lowered distance).

The bed system 100, such as the exemplary module 101 of the bed system 100, comprises a first actuator 130 attached to the second element 120. Alternatively, the first actuator 130 may be attached to the first element 110. In yet another alternative, the first actuator 130 may be attached to both the first element 110 and the second element 120, e.g. at the coupling between the first element 110 and the second element 120, and acting oppositely, e.g. pulling instead of pushing.

The first actuator 130 has a first actuating rod 132 extendible and/or retractable perpendicular to the first hinge axis 138 between a retracted actuator position, as illustrated in FIG. 3a, and an extended actuator position, as illustrated in FIG. 3b. The first actuating rod extends and/or retracts in a space between the first element 110 and the second element 120 to effectuate change of the rotational position of the first element 110 relative to the second element 120, e.g. between the lowered rotational position and the raised rotational position, and/or any position therebetween.

The first element 110 has first wedge structures 116 facing the second element. In the illustrated example, the first element 110 has two first wedge structures (e.g. denoted first primary wedge structure and first secondary wedge structure). However, in other examples, the first element 110 may comprise only one or more first wedge structures. The first wedge structures 116 is positioned to engage with the first actuating rod 132, such that extension of the first actuating rod 132 causes engagement with the first wedge structures 116, such as an engagement surface 117 of the first wedge structures 116, and an oppositely arranged part of the second element 120, such as second wedge structures 126 of the second element 120, as illustrated. Engagement between the first actuating rod 132 and the first and/or second wedge structures 116, 126 results in increase of the angle between the first element 110 and the second element 120, and thereby in increase of the distance between the secondary edge 113 of the first element 110 and the lower surface 121 of the second element 120.

The first actuating rod 132 is T-shaped. The first actuating rod 132 has a longitudinal rod part 134 extending along the direction of extension and/or retraction of the first actuating rod 132.

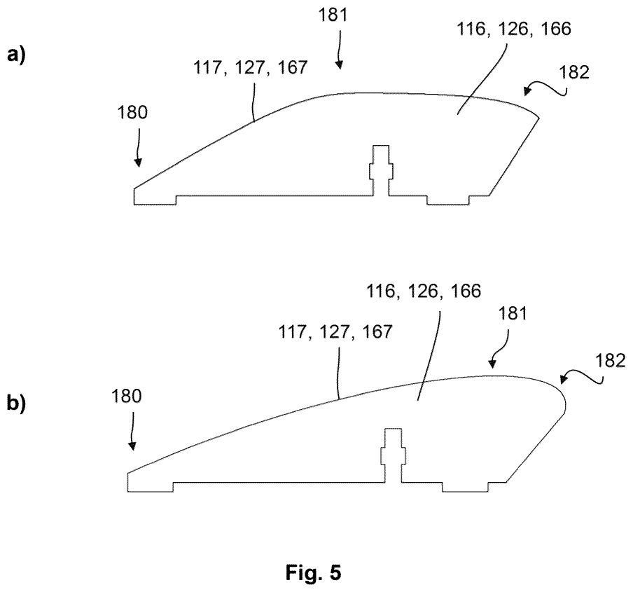

The first actuating rod 132 has a transversal rod part 136 at a distal end of the longitudinal rod part 134. The first wedge structures 116 are arranged on opposite sides of the longitudinal rod part 134. The second wedge structures 126 are also arranged on opposite sides of the longitudinal rod part 134. The first wedge structures 116 and the second wedge structures 126 engage with the transversal rod part 136 of the first actuating rod 132. Some exemplary shapes of wedge structures 116, 126 are illustrated in FIG. 5. An engagement angle of the engagement surface 117 relative to the upper surface of the first element may be gradually decreasing towards the first hinge axis 138. An engagement angle of the engagement surface 127 relative to the lower surface of the second element may be gradually decreasing towards the first hinge axis 138.

The first wedge structures 116 and the second wedge structures 126 are arranged offset along a direction parallel to the hinge axis, to allow the bed system 100 to be as slim as possible in the lowered position.

The first element 110 comprises an opening 118, and/or a plurality of openings, as illustrated, allowing at least a part of the first actuator 130 to protrude through the opening, such as to allow the bed system 100 to be as slim as possible in the lowered position. Although not specifically illustrated, the second element 120 may also or alternatively comprise one or more openings allowing at least a part of the first actuator 130 to protrude through.

In the illustrated example, the bed system 100 is configured such that raising the first element 110 is effectuated by a pushing action of the first actuator 130. However, as also described above, a bed system may be configured such that raising of the first element 110 is effectuated by a pulling action of the first actuator 130. It may further be desired that only raising of the first element 110 is provided as an active process, while lowering may be a passive process, such as to avoid or decrease the risk of pinch injuries. Thus, in the illustrated example, the first actuator 130 may be configured to actively extend the first actuating rod 132 from the retracted actuator position to the extended actuator position, while being configured to release the first actuating rod 132, such as to allow the first actuating rod 132 to retract from the extended actuator position to the retracted actuator position by force being applied to the first element 110, e.g. caused by the weight of the user.

The bed system 100 may, as also illustrated in FIG. 2, comprise both a first module 101A and a second module 101B, similar to the module 101 illustrated in FIG. 3, which may be attached to opposite sides of the bed 2, as seen in FIG. 2, such as to facilitate turning of the person in the opposite direction. Thus, the bed system 100 may in addition to the module 101 illustrated in FIG. 3 comprise a second module comprising a third element similar to the first element 110 and a fourth element similar to the second element 120 hingedly attached along a second hinge axis, and comprising a second actuator attached to the third element and/or the fourth element. The two modules and/or the first actuator and the second actuator may be arranged such that the first actuating rod and the second actuating rod are extending and/or retracting in substantially opposite directions, e.g. extending towards each other. For example, the first actuator and the second actuator may be arranged along the same direction, e.g. such that the first actuating rod and the second actuating rod are extending and/or retracting along substantially the same direction.

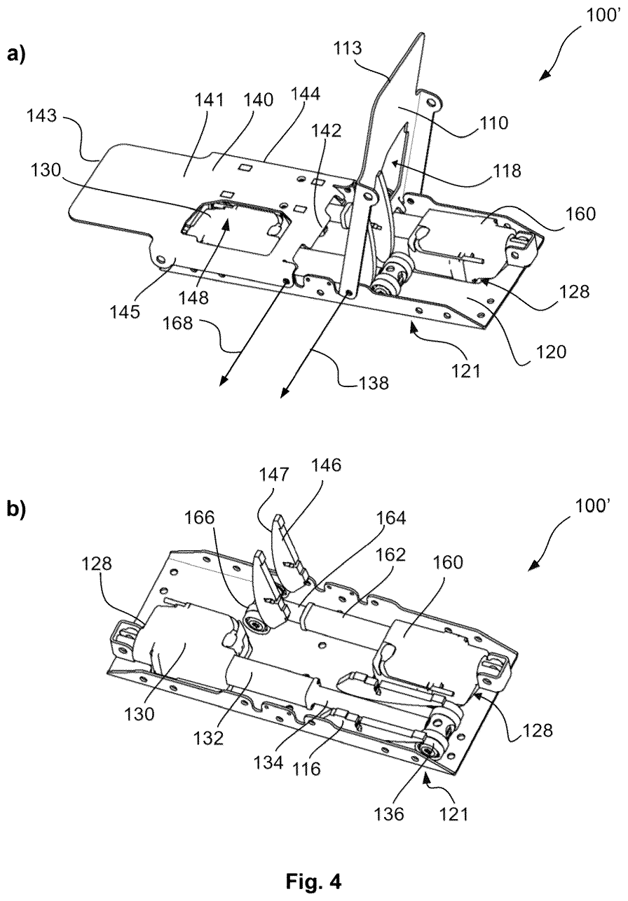

FIG. 4 are schematic diagrams illustrating an exemplary bed system 100′. The exemplary bed system 100′ is attachable to a bed as similarly illustrated in FIG. 2, e.g. by fasteners, such as straps or strips, bolts and nuts and/or screws, such as self-tapping or self-drilling screws, or other means known in the art for attachment.

The bed system 100′ comprises, similar to the bed system 100 as illustrated in FIGS. 2 and 3, a first element 110 and a second element 120. The first element 110 has an upper surface 111 being substantially planar. The second element 120 has a lower surface 121 being substantially planar. The lower surface 121 of the second element 120 is attachable to a top surface of a bed base of the bed, e.g. by fasteners, such as straps or strips, bolts and nuts and/or screws, such as self-tapping or self-drilling screws, or other means known in the art for attachment, such as to arrange the bed system 100′ between the bed base and the mattress of the bed, as illustrated in FIG. 1.

The first element 110 and the second element 120 are hingedly attached along a first hinge axis 138. The upper surface 111 of the first element 110 extends perpendicularly to the first hinge axis 138 from a primary edge 112 to a secondary edge 113 of the first element 110.

Further, the bed system 100′ comprises a third element 140. The third element 140 has an upper surface 141 being substantially planar. The third element 140 and the second element 120 are hingedly attached along a second hinge axis 168, which preferably is parallel to the first hinge axis 138. The upper surface 141 of the third element 140 extends perpendicularly to the second hinge axis 168 from a primary edge 142 to a secondary edge 143 of the third element 140.

In FIG. 4b, the first element 110 and the third element 140 are removed (although wedge structures of the elements 110, 140 are maintained) relative to FIG. 4a to enable a view of otherwise hidden elements. Furthermore, in FIG. 4a the first element 110 is shown in a raised position and the third element 140 is shown in the lowered position. In FIG. 4b, the components are arranged corresponding to the first element being in the lowered position, and the third element being in the raised position.

The bed system 100′ comprises a first actuator 130 and a second actuator 160 attached to the second element 120. The first actuator acts to raise and/or lower the first element 110. The second actuator acts to raise and/or lower the third element 140.

The first actuator 130 has a first actuating rod 132 extendible and/or retractable perpendicular to the first hinge axis 138 between a retracted actuator position and an extended actuator position. The second actuator 160 has a second actuating rod 162 extendible and/or retractable perpendicular to the second hinge axis 168 between a retracted actuator position and an extended actuator position. The first actuating rod 132 extends and/or retracts in a space between the first element 110 and the second element 120 to effectuate change of the rotational position of the first element 110 relative to the second element 120, e.g. between a lowered rotational position and a raised rotational position, and/or any position therebetween. The second actuating rod 162 extends and/or retracts in a space between the third element 140 and the second element 120 to effectuate change of the rotational position of the third element 140 relative to the second element 120, e.g. between a lowered rotational position and a raised rotational position, and/or any position therebetween.

In the lowered rotational position of the first element 110 relative to the second element 120, a lowered distance between the secondary edge 113 of the first element 110 and the lower surface 121 of the second element 120 is less than 8 cm, such as less than 6 cm, such as less than 5 cm, such as less than 4 cm. In a lowered rotational position of the third element 140 relative to the second element 120, a lowered distance between the secondary edge 143 of the third element 140 and the lower surface 121 of the second element 120 is less than 8 cm, such as less than 6 cm, such as less than 5 cm, such as less than 4 cm. Thereby, the bed system 100′ may be fitted between an existing bed base of the bed and a mattress with reduced need to alter the height of a bed rail, while providing a possibility of fitting the bed system 100′ to a bed with a reduced need of altering the bed base, as parts extending below the lower surface 121 is dispensed with or at least reduced.

In the raised rotational position, a raised distance between the secondary edge 113, 143 of the first element 110 and/or third element 140 and the lower surface 121 of the second element 120 is more than the respective lowered distance, such as at least 5 cm more than the lowered distance, such as at least 8 cm, 10 cm, 15 cm, or 20 cm, more than the lowered distance. In some situations, e.g. when turning the person during sleep, the first element 110 and/or the third element 140 may be raised to a lower than maximum raised position during turning, while the maximum raised position may be used when the system 100′ is used during repositioning of the person. In some examples the maximum raised position, e.g. wherein the angle between the first element 110 and/or the third element 140 and the second element 120 is above 70 degrees, may correspond to a raised distance between 34-38 cm (e.g. about 30 cm more than the lowered distance). The angle between the first element 110 and/or the third element 140 and the second element 120 is increased when raising the respective first element 110 and/or third element 140. For example, an angle of 10 degrees may result in a raised distance between 10-14 cm (e.g. about 6 cm more than the lowered distance), an angle of 40 degrees may result in a raised distance between 25-29 cm (e.g. about 21 cm more than the lowered distance), and an angle of 70 degrees may result in a raised distance between 33-37 cm (e.g. about 29 cm more than the lowered distance).

The first actuator 160 and the second actuator 130 may be arranged such that the first actuating rod 132 and the second actuating rod 162 are extending and/or retracting in substantially opposite directions. For example, the first actuator 130 and the second actuator 160 may be arranged side by side, as illustrated, e.g. such that the first actuating rod 132 and the second actuating rod 162 are extending and/or retracting along substantially parallel offset directions.

The first element 110, the third element 140 and optionally the second element 120 (although not illustrated in the example) may comprise respective wedge structures. For example, as illustrated, the first element 110 may comprise first wedge structures 116 facing the second element 120. The third element 140 may comprise third wedge structures 146 facing the second element 120. In the illustrated example, the first element 110 has two first wedge structures (e.g. denoted first primary wedge structure and first secondary wedge structure) and the third element 130 has two third wedge structures (e.g. denoted third primary wedge structure and third secondary wedge structure). However, in other examples, the first element 110, the second element 120 and/or the third element 140 may comprise only one or more wedge structures.

The first wedge structures 116 are positioned to engage with the first actuating rod 132, such that retraction of the first actuating rod 132 causes engagement with the first wedge structures 116, such as with an engagement surface 117 of the first wedge structures 116, and an oppositely arranged part of the second element 120. The third wedge structures 146 are positioned to engage with the second actuating rod 162, such that retraction of the second actuating rod 162 causes engagement with the third wedge structures 146, such as with an engagement surface 147 of the third wedge structures 146, and an oppositely arranged part of the second element 120. In the present example, the oppositely arranged parts of the second element 120, both with respect to the first wedge structures 116 and the third wedge structures, are merely areas of an upper surface of the second element 120. However, as illustrated in FIG. 3, second wedge structures could alternatively be provided in these areas.

Engagement between the first actuating rod 132 and the first wedge structures 116 and engagement between the second actuating rod 162 and the third wedge structures 146 result in increase of the angle between the first element 110 and the second element 120 and between the third element 140 and the second element 120, respectively, and thereby in increase of the distance between the secondary edge 113 of the first element 110 and the lower surface 121 of the second element 120 and in increase of the distance between the secondary edge 113 of the third element 140 and the lower surface 121 of the second element 120.

The first actuating rod 132 and the second actuating rod 162 are T-shaped. Each of the first actuating rod 132 and the second actuating rod 162 has a longitudinal rod part 134, 164 extending along the direction of extension and/or retraction of the respective actuating rod 132, 162. Each of the first actuating rod 132 and the second actuating rod 162 has a transversal rod part 136, 166 at a distal end of the respective longitudinal rod part 134, 164.

The first and second wedge structures 116, 146 are arranged on opposite sides of the respective longitudinal rod parts 134, 164. The first and second wedge structures 116, 146 engage with the transversal rod part 136, 166 of the respective actuating rod 132, 162. Some exemplary shapes of wedge structures 116, 166 are illustrated in FIG. 5. An engagement angle of the engagement surface 117, 167 relative to the upper surface of the respective element 110, 140 may be gradually decreasing towards the respective hinge axis 138, 168.

The first element 110 comprises a first opening 118 allowing at least a part of the second actuator 160 to protrude through the first opening 118. The third element 140 comprises a third opening 148 allowing at least a part of the first actuator 130 to protrude through the third opening 148. The second element 120 comprises two second openings 128 respectively allowing at least a part of the first actuator 130 and the second actuator 160 to protrude through. The openings of the first element 110, the second element 120 and the third element 140 facilitates the bed system 100′ to be as slim as possible in the lowered position.

In the illustrated example, the bed system 100′ is configured such that raising the first and third elements 110, 140 are effectuated by a pulling action of the first and second actuators 130, 160. However, as illustrated in FIG. 3, a bed system may be configured such that raising of the elements 110, 140 are effectuated by a pushing action of the actuators. It may further be desired that only raising of the elements 110, 140 are provided as an active process, while lowering of the elements 110, 140 may be a passive process, such as to avoid or decrease the risk of pinch injuries. Thus, in the illustrated example, the first actuator 130 and/or the second actuator 160 may be configured to actively retract the respective actuating rod 132, 162 from the extended actuator position to the retracted actuator position, while being configured to release the actuating rod 132, 162, such as to allow the actuating rod 132, 162 to extend from the retracted actuator position to the extended actuator position by force being applied to the first element 110 and/or the third element 140, e.g. caused by the weight of the person.

The bed system 100′ may, similarly as described in relation to FIG. 2, comprise one or more primary extension elements and/or one or more secondary extension elements. For example, the bed system 100′ may comprise a first primary extension element flexibly attached to a head side end of the first element 110. The bed system 100′ may comprise a first secondary extension element flexibly attached to a foot side end of the first element 110. The bed system 100′ may comprise a third primary extension element flexibly attached to a head side end of the third element 140. The bed system 100′ may comprise a third secondary extension element flexibly attached to a foot side end of the third element 140.

FIGS. 5a and 5b schematically illustrate two different exemplary shapes of wedge structures 116, 126, 166, where it is seen that the angle of the engagement surface 117, 127, 167 (e.g. relative to an upper surface of the element to which it is attached, see FIGS. 3 and 4, corresponding to horizontal in the figure) may gradually change, such as decrease towards the respective hinge axis (corresponding to the right side of the figure). As seen, the engagement surface 117, 127, 167 may be curved. Furthermore, it may be seen that the angle of the engagement surface 117, 127, 167 may be zero, i.e. the engagement surface is parallel with the upper surface of the element to which it is attached, at an intermediate engagement surface position 181 between an initial engagement surface position 180 and a final engagement surface position 182. The initial engagement surface position 180 is the part of the engagement surface engaging with the respective actuating rod in the lowered rotational position of the element. The final engagement surface position 182 is closer to the respective hinge axis than the initial engagement surface position 180.

The disclosure has been described with reference to a preferred embodiment. However, the scope of the invention is not limited to the illustrated embodiment, and alterations and modifications can be carried out without deviating from the scope of the invention.

Throughout the description, the use of the terms “first”, “second”, “third”, “fourth”, “primary”, “secondary”, “tertiary” etc. does not imply any particular order or importance, but are included to identify individual elements. Furthermore, the labelling of a first element does not imply the presence of a second element and vice versa.

### LIST OF REFERENCES

2 bed
4 bed base
6 top surface
8 mattress
10 head end
12 foot end
14 slats
20 person
100, 100′ bed system
101, 101A, 101B module
110 first element
111 upper surface of first element
112 primary edge of first element
113 secondary edge of first element
114 head end of first element
115 foot end of first element
116 first wedge structure(s)
117 engagement surface of first wedge structure(s)
118 first opening
120 second element
121 lower surface of second element
126 second wedge structure(s)
127 engagement surface of second wedge structure(s)
128 second opening
130 first actuator
132 first actuating rod
134 longitudinal rod part of first actuating rod
136 transversal rod part of first actuating rod
138 first hinge axis
140 third element
141 upper surface of third element
142 primary edge of third element
143 secondary edge of third element
144 head end of third element
145 foot end of third element
146 third wedge structure(s)
147 engagement surface of third wedge structure(s)
148 third opening
160 second actuator
162 second actuating rod
164 longitudinal rod part of second actuating rod
166 transversal rod part of second actuating rod
168 second hinge axis
170 first primary extension element
171 upper surface of first primary extension element
172 first secondary extension element
173 upper surface of first secondary extension element
180 initial engagement surface position
181 intermediate engagement surface position
182 final engagement surface position

1-20. (canceled)

21. A bed system attachable to a bed for turning a person, the bed system comprising a first element and a second element, the first element has an upper surface being substantially planar and the second element has a lower surface being substantially planar,
the lower surface of the second element is attachable to a top surface of a bed base of the bed, such as to arrange the bed system between the bed base and the mattress of the bed,
the first element and the second element being hingedly attached along a first hinge axis, the upper surface of the first element extends perpendicularly to the first hinge axis from a primary edge to a secondary edge of the first element,
wherein in a lowered rotational position of the first element relative to the second element, a lowered distance between the secondary edge of the first element and the lower surface of the second element is less than 8 cm, and wherein in a raised rotational position, a raised distance between the secondary edge of the first element and the lower surface of the second element is at least 5 cm more than the lowered distance,
the bed system further comprises a first actuator attached to the first element and/or the second element, the first actuator having a first actuating rod extendible and/or retractable perpendicular to the first hinge axis between a retracted actuator position and an extended actuator position, and the first actuating rod extending and/or retracting in a space between the first element and the second element to effectuate change of the rotational position of the first element relative to the second element between the lowered rotational position and the raised rotational position.

22. Bed system according to claim 21, comprising a third element the third element has an upper surface being substantially planar,
the third element and the second element being hingedly attached along a second hinge axis, preferably parallel to the first hinge axis, the upper surface of the third element extends perpendicularly to the second hinge axis from a primary edge to a secondary edge of the third element,
wherein in a lowered rotational position of the third element relative to the second element, a lowered distance between the secondary edge of the third element and the lower surface of the second element is less than 8 cm, and wherein in a raised rotational position, a raised distance between the secondary edge of the third element and the lower surface of the second element is at least 5 cm more than the lowered distance,
the bed system further comprises a second actuator attached to the third element and/or the second element, the second actuator having a second actuating rod extendible and/or retractable perpendicular to the second hinge axis between a retracted actuator position and an extended actuator position, and the second actuating rod extending and/or retracting in a space between the third element and the second element to effectuate change of the rotational position of the third element relative to the second element between the lowered rotational position and the raised rotational position.

23. Bed system according to claim 21, comprising a third element and a fourth element, the third element has an upper surface being substantially planar and the fourth element has a lower surface being substantially planar,
the third element and the fourth element being hingedly attached along a second hinge axis, the upper surface of the third element extends perpendicularly to the second hinge axis from a primary edge to a secondary edge of the third element,
wherein in a lowered rotational position of the third element relative to the fourth element, a lowered distance between the secondary edge of the third element and the lower surface of the fourth element is less than 8 cm, and wherein in a raised rotational position, a raised distance between the secondary edge of the third element and the lower surface of the fourth element is at least 5 cm more than the lowered distance,
the bed system further comprises a second actuator attached to the third element and/or the fourth element, the second actuator having a second actuating rod extendible and/or retractable perpendicular to the second hinge axis between a retracted actuator position and an extended actuator position, and the second actuating rod extending and/or retracting in a space between the third element and the fourth element to effectuate change of the rotational position of the third element relative to the fourth element between the lowered rotational position and the raised rotational position,
wherein the lower surface of the fourth element is attachable to the top surface of the bed base of the bed.

24. Bed system according to claim 22, wherein the first hinge axis and the second hinge axis are substantially parallel and wherein the first actuating rod and the second actuating rod are extending and/or retracting in substantially opposite directions, e.g. extending towards each other.

25. Bed system according to claim 22, wherein the first actuator and the second actuator are arranged side by side such that the first actuating rod and the second actuating rod are extending and/or retracting along substantially parallel offset directions.

26. Bed system according to claim 21, wherein the first element has one or more first wedge structures facing the second element, the one or more first wedge structures being positioned to engage with the first actuating rod, such that extension or retraction of the first actuating rod causes engagement with the one or more first wedge structures and an oppositely arranged part of the second element resulting in increase of the angle between the first element and the second element.

27. Bed system according to claim 26, wherein the first actuating rod is T-shaped having a longitudinal rod part extending along the direction of extension and/or retraction of the first actuating rod and a transversal rod part at a distal end of the longitudinal rod part, wherein the one or more first wedge structures comprises a first primary wedge structure and a first secondary wedge structure being arranged on opposite sides of the longitudinal rod part of the first actuating rod, and wherein the one or more first wedge structures engage with the transversal rod part of the first actuating rod.

28. Bed system according to claim 26, wherein the one or more first wedge structures each comprises an engagement surface facing the second element, and wherein an engagement angle of the engagement surface relative to the upper surface of the first element optionally is gradually decreasing towards the first hinge axis and/or optionally has a magnitude of less than 45 degrees, such as less than 35 degrees.

29. Bed system according to claim 26, wherein the engagement of the first actuating rod with the one or more first wedge structures results in change of the rotational position of the first element relative to the second element from the lowered rotational position to the raised rotational position.

30. Bed system according to claim 21, wherein the first actuating rod is not coupled to the first element and is not coupled to the second element.

31. Bed system according to claim 21, wherein a distance between the first hinge axis and the secondary edge of the first element is more than 250 mm, such as more than 275 mm, such as more than 300 mm.

32. Bed system according to claim 21, wherein the upper surface of the first element is formed by a first plate element having a thickness between 0.1 mm and 10 mm, such as between 0.1 mm and 5 mm, such as between 0.1 mm and 2.5 mm.

33. Bed system according to claim 21, wherein the first element and/or the second element comprises an opening allowing at least a part of the first actuator to protrude through the opening.

34. Bed system according to claim 21, wherein the first element comprises a first opening allowing at least a part of the second actuator to protrude through the first opening and optionally wherein the third element comprises a third opening allowing at least a part of the first actuator to protrude through the third opening.

35. Bed system according to claim 21, wherein the first actuator is configured to actively extend the first actuating rod from the retracted actuator position to the extended actuator position, and wherein the first actuator is configured to release the first actuating rod, such as to allow the first actuating rod to retract from the extended actuator position to the retracted actuator position by force being applied to the first element and/or the second element.

36. Bed system according to claim 21, wherein the first actuator is configured to actively retract the first actuating rod from the extended actuator position to the retracted actuator position, and wherein the first actuator is configured to release the first actuating rod, such as to allow the first actuating rod to extend from the retracted actuator position to the extended actuator position by force being applied to the first element and/or the second element.

37. Bed system according to claim 21 wherein the first element extends from a head side end to a foot side end along the first hinge axis, and
the bed system comprising a first primary extension element flexibly attached to the head
side end of the first element, wherein the first primary extension element has an upper
surface being substantially planar, and/or the bed system comprising a first secondary
extension element flexibly attached to the foot side end of the first element, wherein the
first secondary extension element has an upper surface being substantially planar.

38. A bed comprising a bed base with a top surface for supporting a mattress, the bed further comprising a bed system according to claim 21, wherein the second element of the bed system is attached to the top surface such that the bed system is arranged between the bed base and the mattress.

39. Bed according to claim 38, wherein the second element is attached to the top surface at a position corresponding to the hip of the person, and optionally wherein the fourth element is attached to the top surface at a position corresponding to the hip of the person.

40. Bed system assembly comprising a bed system according to claim 21, the bed system assembly further comprising a control unit having a processing unit and electronic memory, wherein the control unit is connected to the first actuator and adapted to control extension and/or retraction of the first actuator.
